(19) United States
(12) Patent Application Publication
(10) Pub. No.: US 2016/0034304 A1
(43) Pub. Date: Feb. 4, 2016

(54) DEPENDENCE TRACKING BY SKIPPING IN USER MODE QUEUES

(71) Applicant: Advanced Micro Devices, Inc., Sunnyvale, CA (US)

(72) Inventors: Vinod TIPPARAJU, Austin, TX (US); Lee W. HOWES, Austin, TX (US); Thomas R.W. SCOGLAND, Blacksburg, VA (US)

(21) Appl. No.: 14/446,177

(22) Filed: Jul. 29, 2014

(51) Int. Cl. G06F 9/48

(52) U.S. Cl. CPC G06F 9/4881

(57) ABSTRACT

A system and methods embodying some aspects of the present embodiments for maintaining compact in-order queues are provided. The queue management method includes requesting a work pointer from a primary queue, wherein the work pointer points to a work assignment comprising an indirect queue and a dependency list; responsive to the dependency list not being cleared, invalidating the work pointer in the primary queue and adding a new pointer to the end of the primary queue, the new pointer configured to point to the work assignment; and responsive to the dependency list being clear, removing the work pointer from the primary queue and performing work in the indirect queue.

### FIELD

The embodiments are generally directed to queue management. More particularly, the embodiments are directed to maintaining compact in-order queues.

### BACKGROUND

Complexity of applications and computer programs continues to increase as users expect more functions from smaller and smaller devices. In order to meet this demand, many products now include multiple ways to process information. Also, designers have started developing ways in which processing units, for example standalone processing units, multiple processing units on a single silicon die, or multiple processing units in communication, can be networked or linked to collectively handle multiple interrelated tasks required for an application or program to run. For example, determining an appearance of a scene in a game may require determining the results of previous actions taken, addressing actions taken by other users, identifying foreground and background objects, etc.

Tasks are maintained in work queues that may support out of order execution. Pointers to these work queues can be maintained in high-level queues or work pools. These high level queues and work pools are designed to maintain lists of pointers of work that needs to be completed.

In some systems, processing units execute the tasks in work queues based on dependencies for a given task. For example, a main task for displaying the current temperature and weather in Washington, D.C. may depend on two tasks. The first task may retrieve the current precipitation/cloud cover for Washington, D.C. A second task may convert the temperature in Washington D.C. from Celsius to Fahrenheit, and may in turn depend on a third task for retrieving the current temperature in D.C. from a national database. The dependencies need to be tracked and cleared before subsequent work is performed. Dependency tracking/clearing can be done by tracking the interaction between tasks and hosts. This tracking involves complex logic and introduces additional latencies in executing the tasks. In the above example, for instance, the first task can execute in parallel with the second and third tasks, but the second task cannot be executed until the third task completes. And the main task cannot execute until all three other tasks are complete. These tasks can be assigned to multiple processing units. The hosts must coordinate the processing units activities so that each task start execution when it is ready. For example, a task will not start execution until all of the task that the task depends on have executed.

To avoid this complex logic, tasks that are not ready to be executed can be skipped. But skipping creates gaps or bubbles in the queue that must later be compacted to avoid running out of queue space, which introduces more latency into the system.

### BRIEF SUMMARY

Therefore, a system and method are provided that allow for efficiently maintaining compact queues.

A system, method, and memory device embodying some aspects of the present embodiments for queue management. The queue management method includes requesting a work pointer from a primary queue, wherein the work pointer points to a work assignment comprising an indirect queue and a dependency list; determining whether the dependency list is cleared; in response to the dependency list not being cleared, invalidating the work pointer in the primary queue and adding a new pointer that points to the work assignment to an end of the primary queue; and in response to the dependency list being clear, invalidating the work pointer in the primary queue and performing work in the indirect queue.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate some embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 shows a primary queue with associated work assignments, according to an embodiment.

FIG. 2 is a flow chart depicting a method of identifying work ready to be completed, according to an embodiment.

FIG. 3 shows an operation that adds work to a primary queue, according to an embodiment.

FIG. 4 shows an operation for executing part of the work in a work assignment, according to an embodiment.

### DETAILED DESCRIPTION

Computers often execute multiple complex programs concurrently. For example, a user may access a word processing, web surfing, data processing, and e-mail program concurrently. Each program may request one or more tasks to be completed. Thus, the computer may receive requests to complete multiple tasks, from one or more of these programs, concurrently. Depending on the requested tasks, the computer may not be able to start work on all of them immediately. The computer may store tasks that are not executed immediately. For example, the computer may place these tasks in a queue. Tasks can be removed from the storage area when resources become available, or added to the storage area when programs request additional work. But these storage areas have a limited amount of space. Once filled, the computer cannot accept additional work until unused storage space is identified.

In addition, each of the stored tasks may be dependent on different information. For example, some may be waiting for the processor to become available, others for input from a user, and still other may be waiting for previous requested tasks to be complete. The computer identifies tasks that are ready to be executed, executes one or more identified tasks, and removes the executed tasks from the storage area. This can create holes within the storage area as certain tasks are removed and others remain. These holes can be difficult to identify and to fill. Identifying these holes requires searching the entire storage area for unallocated space. Filling these holes requires finding tasks that do not exceed the size of an available hole.

Below is a detailed description of efficiently maintaining the storage space using a dependency list. Each task can be evaluated in order. If the task is ready to be executed, it is executed. If the task is not ready to be executed, the task is moved to the end of the storage space and the next task is analyzed. This allows tasks to be continuously evaluated without creating holes within the storage space—allowing for more efficient storage space management and less latency in executing tasks.

In order to efficiently store tasks, some processors store fixed-sized pointers to tasks, rather than the tasks themselves. Thus, the processor can store a fixed number of pointers independent of how large the tasks are.

The following detailed description refers to the accompanying drawings that illustrate exemplary embodiments. Other embodiments are possible, and modifications can be made to the embodiments within the spirit and scope of the description. Therefore, the detailed description is not meant to limit scope. Rather, the scope of the claimed subject matter is defined by the appended claims.

It would be apparent to a person skilled in the relevant art that the embodiments, as described below, can be implemented in many different embodiments of software, hardware, firmware, and/or the entities illustrated in the figures. Thus, the operational behavior of embodiments will be described with the understanding that modifications and variations of the embodiments are possible, given the level of detail presented herein.

This specification discloses one or more systems that incorporate the features of some embodiments. The disclosed systems merely exemplify the embodiments. The scope of the embodiments is not limited to the disclosed systems. The scope is defined by the claims appended hereto.

A person skilled in the art would understand that references to a processing unit could be any type of processing unit, e.g., a central processing unit, an advanced processing unit, a graphics processing unit, an application specific integrated circuit, a field programmable gate array, etc.

The systems described, and references in the specification to “one system”, “a system”, “an example system”, etc., indicate that the systems described may include a particular feature, structure, or characteristic, but every embodiment may not necessarily include the particular feature, structure, or characteristic. Moreover, such phrases are not necessarily referring to the same system. Further, when a particular feature, structure, or characteristic is described in connection with a system, it is understood that it is within the knowledge of one skilled in the art to affect such feature, structure, or characteristic in connection with other embodiments whether or not explicitly described.

### 1. Queue System.

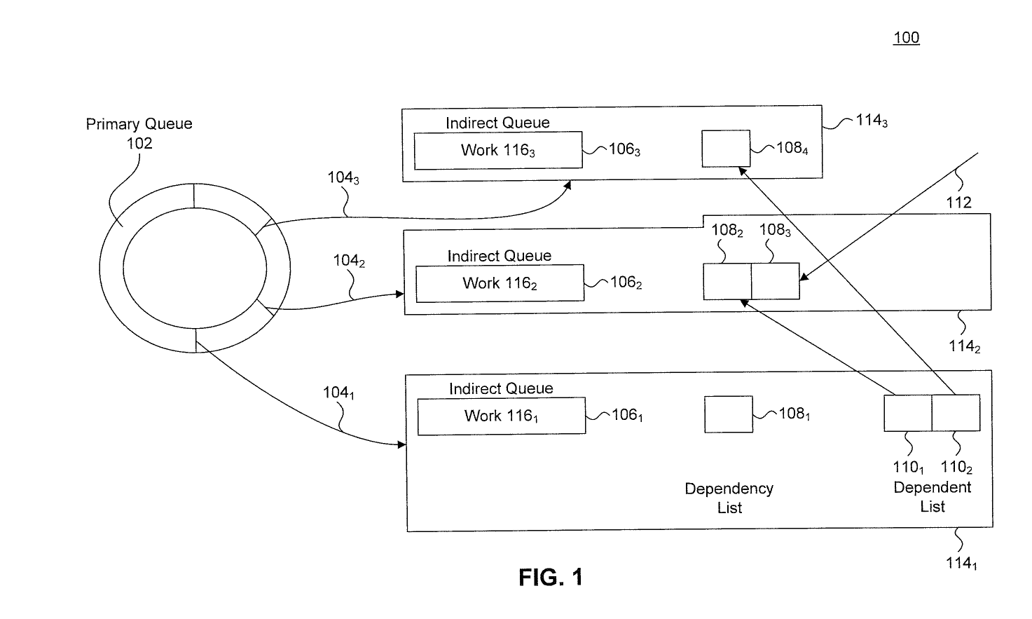

FIG. 1 shows a system 100, in which embodiments described herein can be implemented. In this example, system 100 includes a primary queue 102 containing three work pointers 104₁₋₃, where each work pointer 104 points to a work assignment 114, for example work assignments 114₁₋₃. In this example, each work assignment 114 includes an indirect queue 102, a dependency list 108 and a dependent list 110. Each indirect queue 102 includes work 116 to be executed.

The primary queue 102 can be an in-order queue, for example a first-in-first-out (FIFO) queue. When a pointer 104 is added to the primary queue 102, pointer 104 is added to the end of the primary queue 102. When a processing unit (not shown) requests a task from the primary queue 102, for example after the processing unit has completed a previously assigned task, pointer 104 is invalidated in primary queue 102 and sent to the processing unit. Invalidating pointer 104 allows the task associated with the work pointer to be executed only once by only one processor. In other examples, there are other ways to invalidate a pointer including removing the pointer in the queue, by clearing an associated valid bit, by incrementing a queue pointer to point to the next work pointer in the queue, or the like.

Each work assignment 114 has an indirect queue 106 and can have one or more dependency lists 108 and dependent lists 110. The indirect queue 106, for example indirect queues 106₁₋₃, stores the work 116 to be processed for that work assignment 114. For example, each indirect queue 106 can contain work 116 to render a different portion of a scene.

The dependency list 108 indicates that before the work 116 in the indirect queue 106 can be processed some other condition must be met. The condition can be an internal condition, for example that the work 116₁ in another indirect queue 106₁ must be complete before the work 116₂ in the indirect queue 106₂ can begin executing. Alternatively, the condition can be an external condition, for example that a user must execute a specific action 112 before the work 116₂ in the indirect queue 106₂ can begin executing. Once the conditions on the dependency list 108₂₋₃ clear, the work 116₂ in the indirect queue 106₂ executes.

Each dependent list 110 tracks the dependency lists 108 that are associated with a work assignment 114. For example, when work 116₁ completes execution, work assignments 114 that depend on the results of work 116₁ need to be informed that work 116₁ has completed. Dependent list 110₁₋₂ point to dependency lists 108₂ and 108₄, that need to be cleared. Thus, when the processing unit completes work 116₁, the processing unit can use dependent list 110₁₋₂ to clear dependency list 108₂ and 108₄.

The dependency list 108 can be maintained in many different ways. In an embodiment, a dependency list 108 can link dependencies to internal or external events. For example, in FIG. 1, the dependency list 108 for work assignment 114₂ has two elements, dependency lists 108₂ and 108₃. Dependency list 108₂ is linked to the dependent list 110₁, and will get cleared when the work 116₁ in indirect queue 106₁ is completed. Dependency list 108₃ is linked to an external event. Once an external event 112 has happened, for example a user answered a question, a certain amount of time has passed, a location has been reached, etc., the processing unit handling the external event 112 can clear the dependency list 108, for example dependency list 108₃.

In an embodiment, a dependency list 108 can be a counter (not shown) that indicates how many dependency lists 108 need to be cleared before the work 116 in the associated indirect queue 106 can being execution. For example, in FIG. 1, the dependency list 108₄ for work assignment 114₃ could be a counter. When the work 116₁ in indirect queue 106₁ is completed, dependent list 110₂ can indicate that dependency list 108₄ needs to be decremented. In this example, when the dependency list 108 associated with an indirect queue 106 reaches 0, then the work 116 in the indirect queue 106 is ready to be executed.

### 2. Primary Queue Work Execution Process

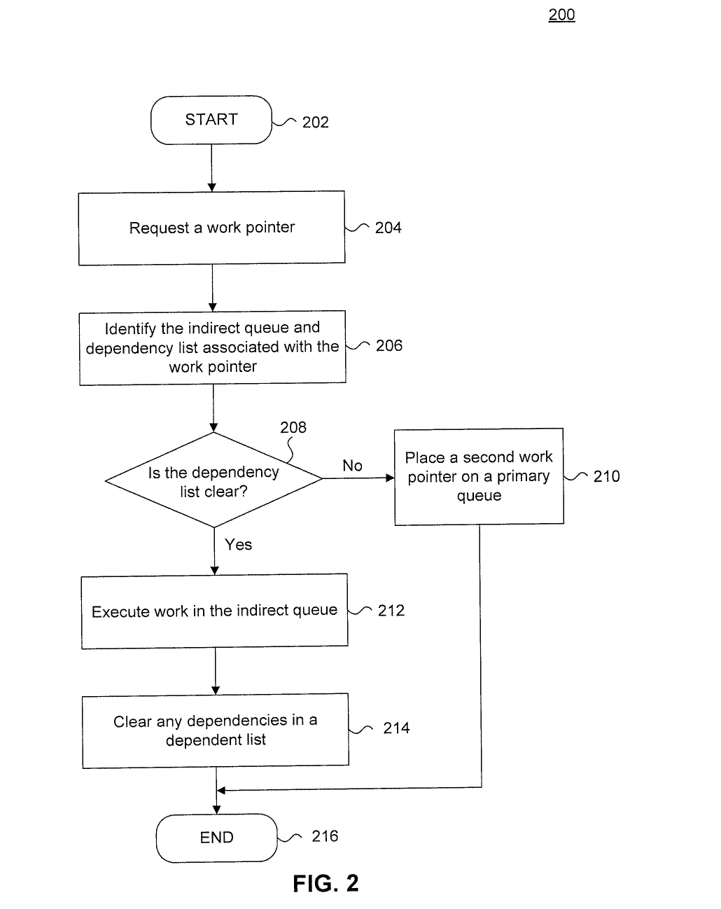

FIG. 2 shows a flowchart depicting a method 200, according to an embodiment. For example, method 200 can be used to process work pointers 104 from a primary queue 102 and execute work 116 stored in work assignments 114 pointed to by the primary queue 102. In one example, method 200 may be performed by system 100 to execute work assignments 114₁₋₃ pointed to by work pointers 104₁₋₃ stored on primary queue 102. A person skilled in the art would appreciate that method 200 need not be performed in the order shown, or require all of the operations shown. Merely for convenience, and without limitation, method 200 is described with reference to FIG. 1.

In step 202, method 200 begins.

In step 204, a processing unit (not shown) requests a work pointer 104, for example work pointer 104₁, from a primary queue 102. For example, if system 100 is contained within a single computer, the request can come from a central processing unit. Or, for example, if system 100 is contained within a distributed computing system with multiple computers, the request could come from any processing unit with access to the primary queue 102. A person skilled in the art would understand that these are just two examples of many different environments where system 100 could be applied. When primary queue 102 returns a work pointer 104, for example work pointer 104₁, to the processing unit, primary queue 102 also invalidates the work pointer 104, for example by removing the work pointer 104 or by clearing a valid bit associated with work pointer 104.

In step 206, the processing unit identifies the indirect queue 106 and dependency list 108 associated with the work pointer 104. For example, if work pointer 104₁ was returned by the primary queue 102, the processing unit would identify indirect queue 106₁ and dependency list 108₁ (that are part of work assignment 114₁).

In step 208, the processing unit determines if the dependency list 108 is clear. In an embodiment, the dependency list 108 is a list of work assignment 114 that must be complete before the work 116 in the identified indirect queue 106 can begin execution. The processing unit determines whether each item in the dependency list 108 has been cleared. In another embodiment, the dependency list 108 is a counter of work assignments 114 that must be complete before the work 116 in the identified indirect queue 106 can begin execution. The processing unit determines whether the counter in dependency list 108 is 0.

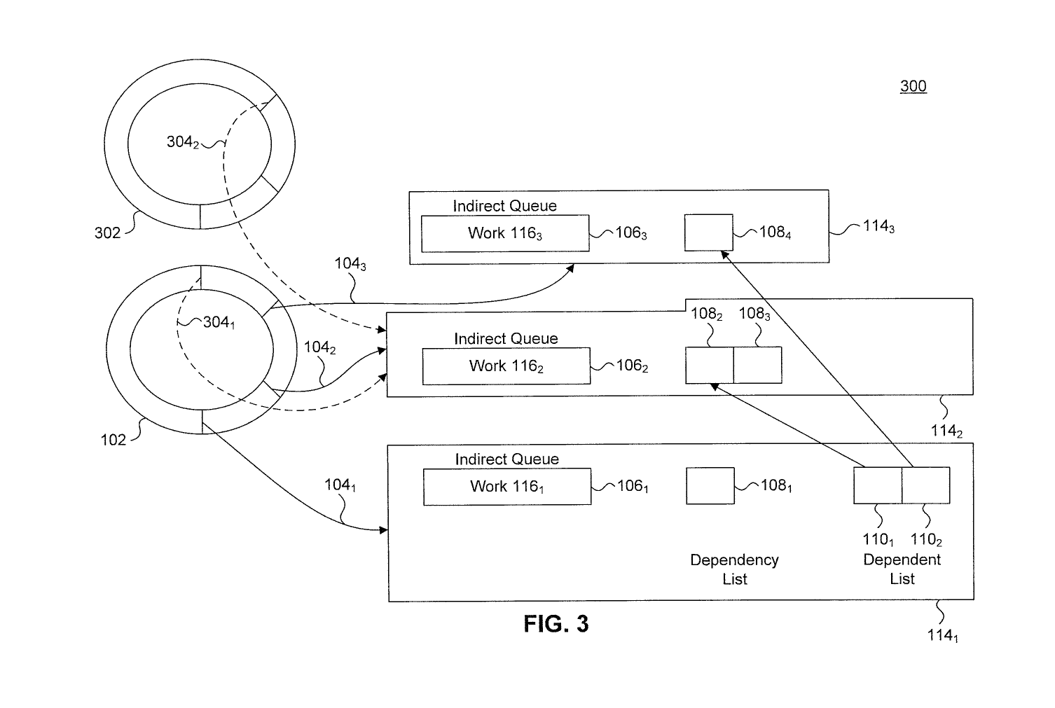

If the dependency list 108 is not clear, then the process continues to step 210. In step 210, a new work pointer 104 is created and placed on a primary queue 102. The new work pointer 104 can either be added to the primary queue 102 that the original work pointer 104 was requested from, or added to a different primary queue 102. This is discussed below in more detail with regard to FIG. 3. Once the new work pointer 104 is placed, the process continues to step 216.

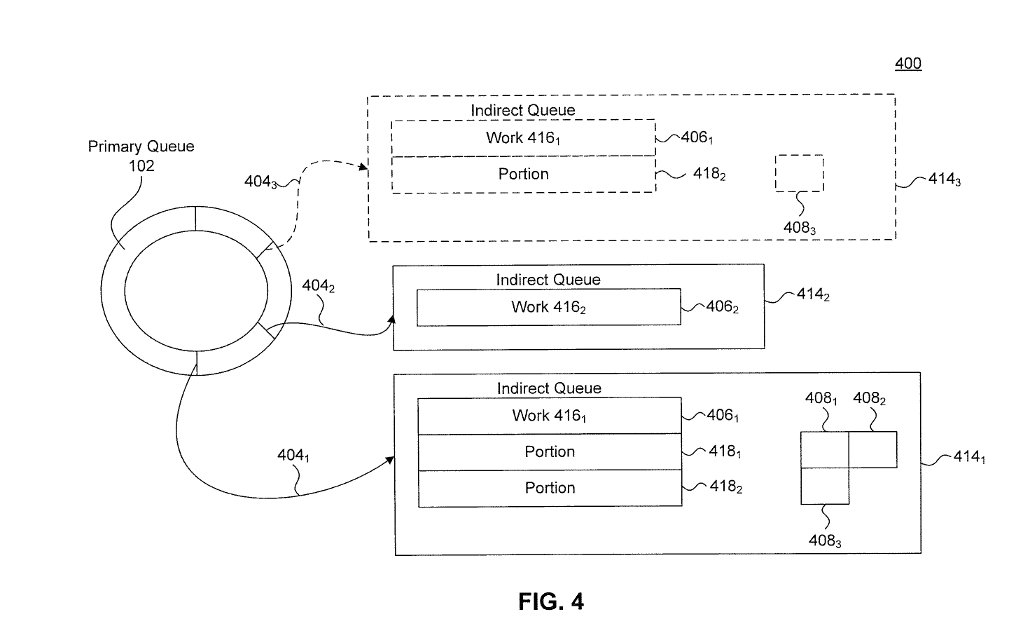

If, in step 208, the dependency list 108 is clear, then the process continues to step 212. At step 212, the processing unit knows that the work 116 in the indirect queue 106 is ready to be executed. The processing unit can execute part or all of the work 116. If only part of the work 116 is executed, a new work pointer 104 can be created. The creation of the new work pointer 104 is discussed in more detail below with regard to FIG. 4. Once part or all of the work 116 has been completed, the process continues to step 214.

At step 214, the processing unit can use the dependent list 110 to clear any dependencies in other work assignment 114's dependency lists 108 that are associated with work 116. In one embodiment, this means clearing the element in a dependency list 108 associated with work 116. In another embodiment, this means decrementing the dependency list 108 counter associated with work 116. The process can then continue to step 216.

At step 216, the processing unit requests a new work pointer 104 from the primary queue 102 since all previous work is complete.

3. Handling Work Assignments that are not Ready to be Executed.

FIG. 3 shows a system 300, in which embodiments described herein can be implemented. In this example, system 300 includes two primary queues 102 and 302. Similar to system 100, primary queue 102 contains three work pointers 104₁₋₃ that point to respective work assignments 114, for example work assignments 114₁₋₃.

In one example, a processing unit (not shown) requests a work pointer 104. Primary queue 102 returns the requested work pointer 104₂ and invalidates work pointer 104₂ in primary queue 102. This could occur, for example, in a single processing unit system if the processing unit requests a new work pointer 104 after completing work 116₁ in indirect queue 106₁. In a multiple processing unit system example, this could occur if two processing units request work pointers 104 from the primary queue 102. A first processing unit receives requested work pointer 104₁ and a second processing unit receives a different requested work pointer 104₂ from primary queue 102. A person skilled in the art would understand that there are other ways a processing unit may receive work pointer 104₂.

In one example, dependency list 108₃ has not yet been cleared, i.e., even though a processing unit has received work pointer 104₂, the processing unit will determine that the dependency lists 108₃ has not been cleared. For example, this situation occurs when the processing unit reaches step 208 in process 200, such that work pointer 104₂ is removed from primary queue 102, but the work 116 in indirect queue 106₂ is not ready to execute. The work 116₂ may not be ready to execute because dependency list 108₃ is not clear. A new work pointer 304 must be added to a primary queue 102 or 302 to allow processing unit the ability to execute the work 116₂ in indirect queue 106₂ at some point in the future.

In one example operation, a new work pointer 304₁ that points to work assignment 114₂ is created and added to the end of primary queue 102. Subsequently, when the processing unit requests a work pointer 104, primary queue 102 returns new work pointer 304₁ The processing unit can then determine if the dependency lists 108₂₋₃ for work assignment 114₂ are clear.

In another example, a new work pointer 304₂ is created and added to a different primary queue 302 than its original primary queue 102, for example the new pointer 304₂ is added to primary queue 302. This can be done for multiple reasons, for example if primary queue 102 is full or if system 300 is designed such that all work 116 that was not ready when first accessed is stored separately. A person skilled in the art would recognize that these are merely examples, and that there are many other reasons and design considerations that may make it desirable to add a work pointer 304 to a different primary queue 302 than where it originated.

### 4. Partial Execution of Work in an Indirect Queue.

FIG. 4 shows a system 400, in which embodiments described herein can be implemented. In this example, system 400 includes a primary queue 102 containing two work pointers 404₁₋₂ pointing to respective work assignments 414, for example work assignments 414₁₋₂.

In an embodiment, work assignment 414₁ contains indirect queue 406₁. The work 416 in indirect queue 406₁ is divided into two portions, 418₁ and 418₂. Each portion 418₁ and 418₂ is associated with its own dependency list 408; portion 418₁ is associated with dependency lists 408₁ and 408₂ and portion 418₂ is associated with dependency list 408₃. For this example, assume that dependency lists 408₁ and 408₂ have been cleared, but that dependency list 408₃ has not been cleared. As discussed above with regard to FIGS. 1 and 2, a processing unit (not shown) can request a work pointer 404, receive work pointer 404₁, and identify an indirect queue 406₁, portions 416₁ and 416₂, and dependency lists 408₁₋₃. Work pointer 404 in primary queue 102 is invalidated. In an embodiment, the processing unit can determine if, where an indirect queue 406 has more than one executable portion 418, one or more portions 418 are ready to be executed. For example, in FIG. 4, portion 416₁ is ready to be executed, since its dependency lists 408₁₋₂ have been cleared. The processing unit can then execute the work 416 in portions 418 that are ready to be executed.

In an example, one or more portions 418 are associated with dependency lists 408 have not been fully cleared. In this case, the processing unit can create a new work assignment 414 and work pointer 404 for those portions 418 that are not ready to be executed, and add them back to a primary queue 102. For example, if portion 416₂ is not ready to be executed because dependency list 408₃ has not been cleared the processing unit can create a new work assignment 414₁, for example work assignment 414₃, containing the indirect queue 406, for example indirect queue 406₁. The indirect queue 406 would only contain the work 416 that has not been executed, for example, portion 416₂. In addition the work assignment 414 would only contain the dependency lists 408 associated with the incomplete work 416, for example dependency list 408₃. The processing unit creates a new work pointer 404, for example 404₃, and adds it to a primary work queue 102, as described with regard to FIG. 3.

Embodiments can be accomplished, for example, through the use of general-programming languages (such as C or C++), hardware-description languages (HDL) including Verilog HDL, VHDL, Altera HDL (AHDL) and so on, or other available programming and/or schematic-capture tools (such as circuit-capture tools). The program code can be disposed in any known computer-readable medium including semiconductor, magnetic disk, or optical disk (such as CD-ROM, DVD-ROM). As such, the code can be transmitted over communication networks including the Internet and internets. It is understood that the functions accomplished and/or structure provided by the systems and techniques described above can be represented in a core (such as a CPU core and/or a GPU core) that is embodied in program code and may be transformed to hardware as part of the production of integrated circuits.

In this document, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These computer program products are means for providing software to an APD.

The embodiments are also directed to computer program products comprising software stored on any computer-usable medium. Such software, when executed in one or more data processing devices, causes a data processing device(s) to operate as described herein or, as noted above, allows for the synthesis and/or manufacture of computing devices (e.g., ASICs, or processors) to perform embodiments described herein. Embodiments employ any computer-usable or computer-readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments as contemplated by the inventors, and thus, are not intended to limit the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature that others can, by applying knowledge within the skill of the relevant art, readily modify and/or adapt for various applications such specific embodiments, without undue experimentation, without departing from the general concept presented. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope should not be limited by any of the above-described exemplary embodiments, but should be defined only in accordance with the following claims and their equivalents.

What is claimed is:

1. A method comprising:
requesting a work pointer from a primary queue, wherein the work pointer points to a work assignment comprising an indirect queue and a dependency list;
responsive to the dependency list not being cleared, invalidating the work pointer in the primary queue and adding a new pointer to the end of the primary queue, the new pointer configured to point to the work assignment; and
responsive to the dependency list being cleared, invalidating the work pointer in the primary queue and performing work in the indirect queue.

2. The method of claim 1, wherein the dependency list is a counter indicating a number of dependencies that have not been cleared.

3. The method of claim 1, wherein the primary queue is a first-in-first-out queue.

4. The method of claim 1, wherein the work assignment further comprises a dependent list pointing to a different dependency list of a different work assignment.

5. The method of claim 4, wherein when the dependency list is clear, further comprising clearing the different dependency list.

6. The method of claim 1, wherein the primary queue comprises two or more storage queues.

7. The method of claim 6, wherein a storage queue stores an unprepared work pointer that points to an unprepared work assignment that was not ready to execute.

8. The method of claim 7, wherein the work pointer is requested from the primary queue and the unprepared work pointer is added to the storage queue.

9. The method of claim 1, wherein:
the indirect queue comprises a first and a second portion of work;
the first portion of work is associated with a first dependency list; and
the second portion of work is associated with a second dependency list.

10. The method of claim 9, wherein when the first dependency list being clear and the second dependency list not being clear, further comprising performing the first portion of work and adding a modified pointer to the end of the primary queue, such that the modified pointer points to a modified work assignment comprising a modified indirect queue containing the second portion of work and the second dependency list.

11. A system comprising:
a primary queue configured to store a work pointer that points to a work assignment, the work assignment comprising an indirect queue and a dependency list; and
a processing unit configured to:
request the work pointer from the primary queue;
responsive to the dependency list not being cleared, invalidate the work pointer in the primary queue and add a new work pointer to an end of the primary queue, wherein the new work pointer is configured to point to the work assignment; and
responsive to the dependency list being cleared, invalidate the work pointer in the primary queue and perform work in the indirect queue.

12. The system of claim 11, wherein the dependency list is a counter indicating a number of dependencies that have not been cleared.

13. The system of claim 11, wherein the primary queue is a first-in-first-out queue.

14. The system of claim 11, wherein the work assignment further comprises a dependent list pointing to a different dependency list of a different work assignment.

15. The system of claim 14, wherein in response to the dependency list being clear, the processing unit is further configured to perform work in the indirect queue and clear the different dependency list.

16. The system of claim 11, wherein the primary queue comprises two or more storage queues.

17. The system of claim 16, wherein the two or more storage queues comprise a storage queue configured to store an unprepared work pointer that points to an unprepared work assignment that was not ready to execute.

18. The system of claim 17, wherein
configuring the processing unit to add the new work pointer comprises adding the new pointer to the storage queue.

19. The system of claim 11, wherein the indirect queue comprises a first and a second portion of work and wherein the first portion of work is associated with a first dependency list and the second portion of work is associated with a second dependency list.

20. The system of claim 19, wherein in response to the first dependency list being clear and the second dependency list not being clear, the processing unit is further configured to perform the first portion of work and add a modified work pointer to the end of the primary queue, wherein the modified work pointer points to a modified work assignment comprising a modified indirect queue containing the second portion of work and the second dependency list.
